(19) United States
(12) Patent Application Publication
(10) Pub. No.: US 2014/0122310 A1
(43) Pub. Date: May 1, 2014

(54) SYSTEMS AND METHODS REGARDING A PURCHASE DECISION TOOL FOR DETERMINING A FINANCIAL IMPACT OF A PROPOSED PURCHASE

(71) Applicant: Strands, Inc., San Mateo, CA (US)

(72) Inventors: Marc TORRENS, San Mateo, CA (US); Jim SHUR, San Mateo, CA (US); Felix GARCIA, San Mateo, CA (US); Edward CHANG, San Mateo, CA (US)

(73) Assignee: Strands, Inc., San Mateo, CA (US)

(21) Appl. No.: 14/067,832

(22) Filed: Oct. 30, 2013

Related U.S. Application Data
(60) Provisional application No. 61/720,792, filed on Oct. 31, 2012.

(51) Int. Cl. G06Q 40/02

(52) U.S. Cl. CPC G06Q 40/02
USPC 705/35

(57) ABSTRACT

The present describes systems and methods to support financial management by determining the impact of a proposed purchase on a financial situation. For example, a device is configured to determine the impact of a proposed purchase on a user's financial situation based on a purchase amount associated with the proposed purchase.

### RELATED APPLICATIONS

This application claims priority to U.S. Provisional Patent Application No. 61/720,792, filed Oct. 31, 2012, titled PURCHASE DECISION SUPPORT TOOL, which is incorporated herein by reference in its entirety.

### COPYRIGHT NOTICE

©2002-2013 Strands, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

The instant patent application describes systems and methods for personal finance management.

### BACKGROUND OF THE INVENTION

An individual or other entity may have one or more incomes, and have expenditures. The expenditures may be associated with a purchase and respective amount. Some possible or potential expenditures may be optional and/or not yet completed. Today, people increasingly carry a mobile device for communication on the go, thus individuals often carry mobile devices and are users of their mobile device(s). Mobile devices often have the capacity to run programs or applications.

### SUMMARY OF THE INVENTION

System(s) and method(s) are provided for determining the impact of a proposed purchase on a computational device user's financial situation using the computational device. Examples of computational devices include personal computers and mobile devices. Such a system for determining the impact of a proposed purchase may comprise a server and a mobile device (or other computational device) in communication with the server. The server stores financial situation data including a balance. The mobile device is configured to communicate with the server to receive the financial situation data. In one embodiment, the mobile device comprises logic configured to determine a state of a tuple of financial indicators. The mobile device is configured to access a budget plan and receive proposed purchase data for a proposed purchase including a purchase amount, and compare the proposed purchase data with the budget plan and the financial situation data to determine the state of the tuple of financial indicators.

Of course the above example system is not limiting and a method might involve accessing a budget plan with a mobile device and receiving financial situation data at the mobile device, wherein the financial situation data includes a balance. The mobile device receives proposed purchase data, wherein the proposed purchase data comprises a purchase amount and perhaps a currency for a proposed purchase. The proposed purchase data is compared with the budget plan and the financial situation data at the mobile device, including comparing the balance with the purchase amount, and a state of a tuple of financial indicators is determined based on comparing the proposed purchase data with the budget plan and the financial situation data. Then output indicating the state of the tuple of financial indicators may be output to the user to indicate the impact of the proposed purchase.

The state of the tuple of financial indicators may be determined as a state of a state machine implemented in the mobile device and the tuple may include two or more elements, each element corresponding to a respective financial indicator and having a corresponding element state. The method may involve selectively maintaining a current state of an element state or transitioning to a different state of an element state based on comparing the proposed purchase data with the budget plan and the financial situation data. A respective element state indicates the impact of the proposed purchase on the corresponding financial indicator.

Comparing the purchase data with the budget plan and the financial situation data may involve calculating a Projected Over Budget value and/or an Actual Over Budget value or other financial parameters. In one example, the proposed purchase is an individual purchase transaction. Aspects of the system(s) and method(s) may be implemented using a computer accessible non-transitory memory medium comprising program instructions stored thereon that, in response to execution by a processing device, cause the processing device to perform operations.

This Summary is provided to provide an overview of aspects of systems and methods and does not limit the scope of this patent application to the aspects and embodiments discussed in this Summary section. For example, depending upon the particular implementation, an array may be used in the place of the above-discussed tuple. Likewise, discussion of the state machine is exemplary only, and other logical implementations are possible consistent with this disclosure, as would be appreciated by one of skill in the art.

### BRIEF DESCRIPTION OF THE DRAWINGS

FIG. 1 shows a system capable of implementing aspects discussed herein;

FIG. 2 is a block diagram of a mobile device of the system of FIG. 1 capable of performing aspects discussed herein;

FIG. 3 is an illustrative example of a spending graph;

FIG. 4 is a flowchart illustrating an example methodology for determining a purchase impact;

FIG. 5 illustrates example possible tuple states; and

FIGS. 6A-6D illustrates graphical user interface aspects of a computer program executed on a mobile device.

### DETAILED DESCRIPTION OF PREFERRED EMBODIMENTS

Aspects regard a purchase decision tool. The purchase decision tool may be implemented with or on a computational and/or mobile device such as a phone, tablet, desktop computer, smart TV, client, or other mobile or computational device. The purchase decision tool outputs purchase impact information related to a proposed purchase. A proposed purchase is a potential, possible or future purchase. The proposed purchase is speculative in that it is not completed and so is not effectuated, consummated, transacted or executed. In one example, the proposed purchase may or may not be an obligatory future purchase, such as, for example, a purchase that is contractually obligated. By providing a user with purchase impact information resulting from the proposed purchase, the user is enabled to make an informed decision as whether to proceed with the proposed purchase and complete the transaction, thereby completing the purchase.

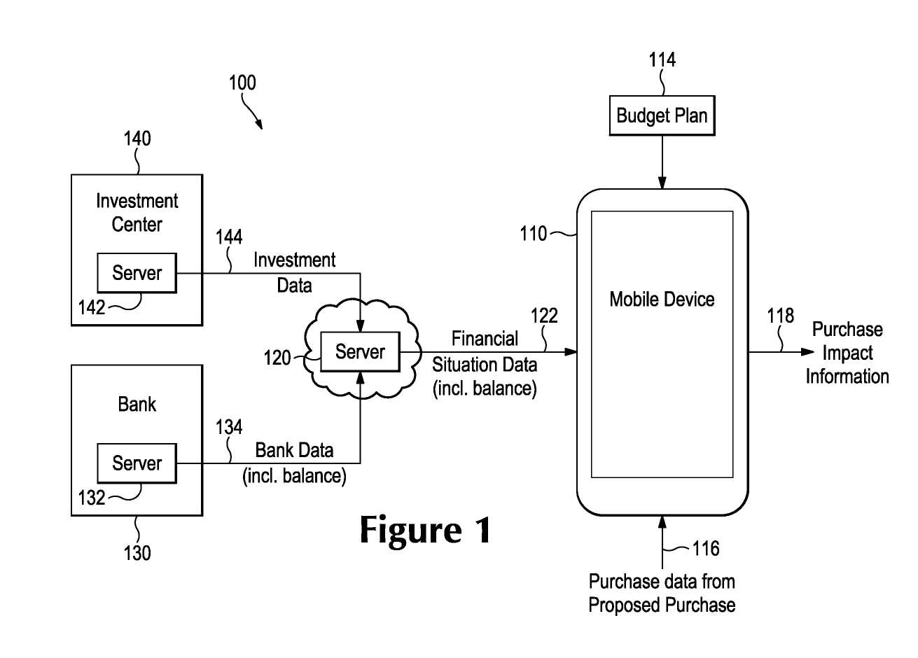

FIG. 1 shows an example system 100 for implementing a purchase decision support tool in a mobile device 110. Mobile device 110 is associated with a user who wishes to know the financial impact of a proposed purchase on his or her finances. Mobile device 110 has been loaded with the purchase decision tool. Mobile device 110 is in communication with server 120 from which mobile device 110 receives financial situation data 122. Financial situation data 122 includes a balance and is associated with the user.

Server 120 is in communication with bank 130 via server 132 which is associated with and under the control of bank 130. Server 120 receives bank data 134 associated with the user associated with mobile device 110, who is referred to hereinafter as the user, from server 132. Server 120 may also be in communication with investment center 140 via server 142 which is associated with and under the control of investment center 140. Server 120 may also receive investment data 144 associated with the user from server 142. Server 120 compiles the bank data 134 including the balance and also perhaps investment data 144 to derive and/or determine financial situation data 122 for the user including the balance. Financial situation data 122 may also include one or more incomes or income streams, for example a monthly income from employment and a yearly income from investments. Financial situation data 122 may be maintained for the user based upon an account for the user and may be updated upon the occurrence of an event, such as a communication from mobile device 110 by the user, or may be periodically updated, or may be updated based upon changes in bank data 134 and investment data 144.

Returning to mobile device 110 and functionality thereof for implementing the purchase decision tool, mobile device 110 receives financial situation data 122 including the balance from server 120. Financial situation data 122 may be pushed to mobile device 110 and/or may be pulled from server 120 by one or more programs running on mobile device 110 as part of the purchase decision tool. Mobile device 110 also accesses budget plan 114 which is a budgeting and spending plan for the user. Budget plan 114 may be stored in memory, or may be obtained by mobile device 110 from an account and/or electronic storage associated with the user, for example from server 120. Budget plan 114 may have previously been designed and/or compiled by the user. Purchase data 116 corresponding to a proposed purchase-which as described above, is a potential, possible or future purchase-is provided to mobile device 110. For example, the user may enter a purchase amount of a proposed purchase as purchase data 116. In any case, purchase data 116 comprises an amount value associated with the proposed purchase and is provided to mobile device 110. Purchase data 116 may also include a spending category for the item associated with the proposed purchase such as groceries, clothes, hobby sport, and other categories. Mobile device 110 compares budget plan 114 and/or financial situation data 122 with purchase data 116 and determines and outputs purchase impact information 118. In some embodiments, this may be done utilizing a state machine, which outputs states based at least in part on purchase data 116.

While budget plan 114 is discussed separately from financial situation data 122, budget plan 114 and/or budget aspects and constraints thereof may be part of or subsumed into financial situation data 122. Similarly, data of financial situation data 122 may be a part of or subsumed into budget plan 114. Server 120 may compile budget aspects or constraints of budget plan 114 and provide such data to mobile device 110. Similar to a budget plan, a user may have or design a savings goal plan which may include planned spending and/or planned savings. The savings goal plan may also include a savings goal buffer. The planned spending or planned saving may be over a time period, such as a month. Thus, mobile device 110 may compare budget plan 114, financial situation data 122, and/or a savings goal plan with purchase data 116 and determine and output purchase impact information 118. Of course a budget plan can be defined as a generic budget over a time period such as a month, or may be defined category by category, or both.

Thus, a budget plan may have categories of spending such as clothes, food, entertainment, travel and other spending categories. Similarly, a savings goal plan may have different categories. For example, different categories to achieve savings in. The impact of a proposed purchase may be determined with regard to categories, for example on a category basis. That is, the impact of a proposed purchase may be determined with regard to a budget category, and the planned savings with regard to that category, for example.

Returning to mobile device 110, in a specific example, purchase data 116 is compared against budget plan 114 and financial situation data 122, including the balance, to determine a state which is indicative of purchase impact information 118. In a further example, the purchase amount of purchase data 116 is fed into a state machine which has been loaded with parameters associated with and/or derived from budget plan 114 and financial situation data 122, and the state machine outputs a state which is indicative of or is or is part of purchase impact information 118.

By way of further example, server 120 is optional, and mobile device 110 may compile and/or aggregate financial situation data 122 from one or more sources via one or more communications over, for example, the internet or other communication connection.

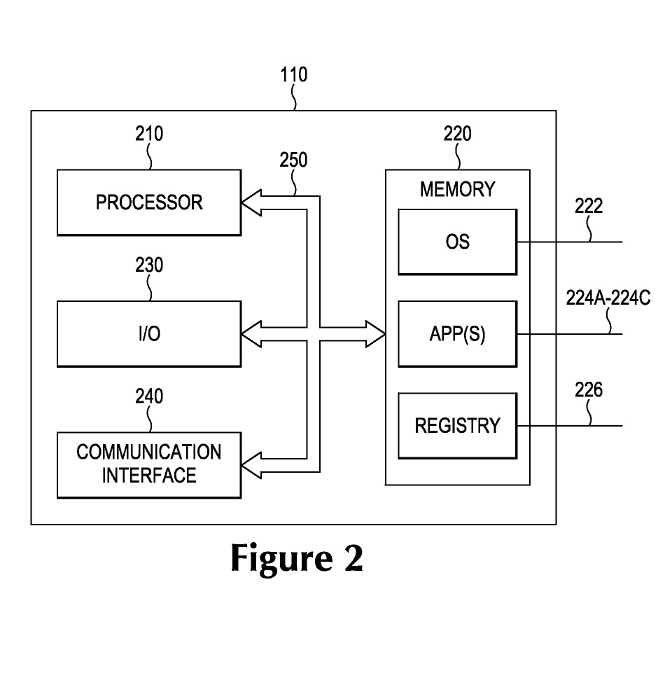

FIG. 2 shows a block diagram example of mobile device 110. As shown, mobile device 110 includes processor 210, memory 220, input/output (I/O) components 230 (which may include, for example, a keyboard, a touch sensitive display) and communication interface 240 for communicating with server 120 or other. In one embodiment, these components are coupled for communication with one another over bus 250. The memory 220 can be implemented as non-volatile electronic memory such as a random access memory (RAM) with a battery back-up module (not shown) such that information stored in the memory 220 is not lost when the general power to mobile device 110 is shut down. A portion of memory 220 is preferably allocated as addressable memory for program execution.

Memory 220 includes operating system 222 and application programs 224A-224C. Operating system 222, during operation, is preferably executed by processor 210. Operating system 222, in one embodiment, is the Windows CE brand operating system commercially available from Microsoft Corporation. Operating system 222 may be designed for mobile devices. Application programs 224A-224C may include the purchase decision tool or provide functions thereof and when one or more programs/functions are executed, may implement state machine 112. Application programs 224A-224C may further include programs and/or subroutines for accessing budget plan 114 and obtaining financial situation data 122.

In addition to application programs 224A-224C and operating system 222, memory 220 further stores registry 226 used in operating systems such as Windows CE brand operating systems. Use of registries such as registry 226 is conventional and provides information related to application programs 224A-224C installed on mobile device 110. In a preferred embodiment, registry 226 stores user settings of the application as well as where particular files are to be stored in tree-type directories, which is a common technique used in many operating systems.

Turning to an example of a possible implementation of a purchase decision tool and operations thereof, a user may set up a monthly budget and this monthly budget may be a comprehensive monthly plan for income, budgeting-including both mandatory and discretionary spending-and savings. This monthly budget may be a budget plan such as budget plan 114 discussed above with regard to FIG. 1. Still further, this monthly budget may include a savings goal plan. The monthly budget may further comprise budget allocations in different categories. When shopping or otherwise considering or contemplating a (proposed) purchase, the user may use his mobile device loaded with the purchase decision tool, for example, mobile device 110 of FIG. 1, and execute functions of the purchase decision tool. More particularly, upon execution, the purchase decision tool, application(s) and/or subroutine(s) thereof, accesses the monthly budget and the user inputs purchase data associated with the proposed purchase including purchase amount. This may be done by inputting the purchase amount via a touchscreen or keypad, or may be done by scanning or otherwise identifying the purchase. The purchase data may further include the currency of the proposed purchase and a spending category. The purchase decision tool then compares the monthly budget with the purchase amount and determines a set of individual qualitative indicators which indicate the impact of the proposed purchase on balance, cash flow, budgets, savings goals and other financial parameters. The amounts and/or values of the financial parameters and/or purchase data may be normalized based on currency-such as the currency that the proposed purchase will be transacted in-so that there is use of a common currency when assessing the proposed purchase against financial parameters. The purchase decision tool may also access and/or receive financial situation data such as the balance as discussed above for purposes of this comparison. And this also may be used to determine the impact of the proposed purchase on a user's financial situation, and such data may also be normalized with respect to currency. The purchase decision tool may further determine an overall qualitative indicator which indicates the overall impact of the proposed purchase on the user's budget and/or financial situation. The purchase decision tool may output one or more of these indicators to the user. In addition, the purchase decision tool may provide a details view in which the indicators and a determined overall score associated with the proposed purchase are explained.

Proceeding with an example of determining the impact of the proposed purchase on a per month basis-that is with regard to the instant month in which the proposed purchase is to be made-the purchase decision tool may access or determine a starting balance (defined as the variable SB) for the month, a planned spending (defined as the variable PS) for the month, a planned savings (defined as the variable SV) for the month and a savings goal buffer (defined as the variable SGB), which also may be for the month. These may be part of a savings goal and/or budget plan. The planned savings for the month is the amount of monthly income not planned to be spent and the savings goal buffer is the amount of current balance not allocated toward predetermined savings goals. The purchase support tool may further access or determine a sum of all monthly budgets (defined as the variable DS).

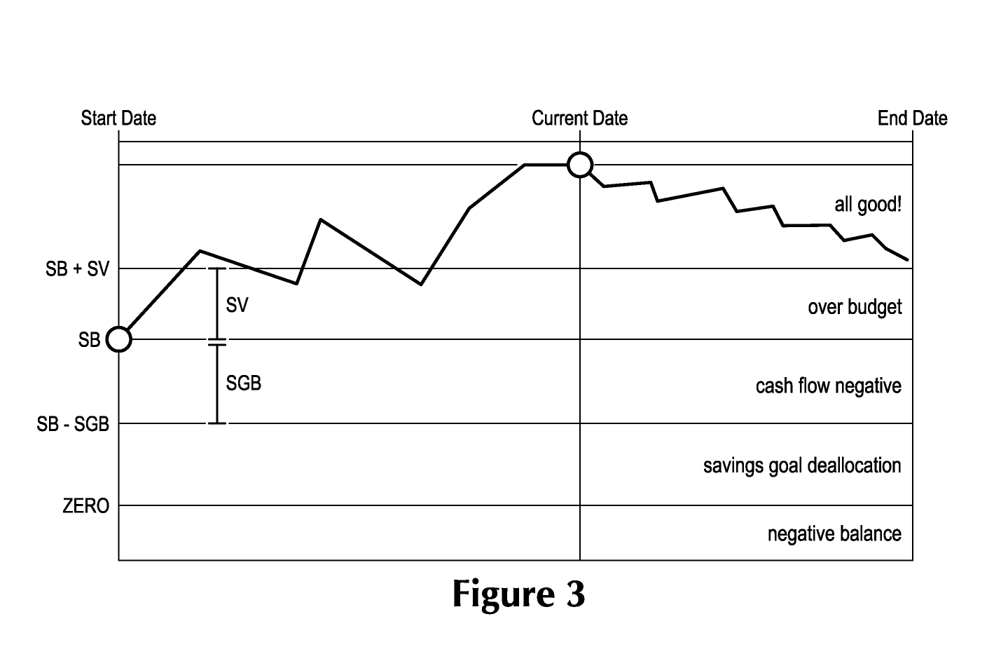

FIG. 3 shows a graph of spending impacts over a period, for example a monthly period. At a Start Date, there is a corresponding starting balance, SB. The graph tracks the impacts of purchases on planned savings, SV, and savings goal buffer, SGB, over the period. The impacts of purchases made, or spending, are determined for the Current Date, and prognosed out to the End Date of the period. Depending on the spending and other parameters, the user may be over budget, have negative cash flow, have savings goal deallocation, or be in negative balance.

The impact of the proposed purchase can be neutral, potentially negative or negative on a financial parameter. For example, a proposed purchase may have no impact on a balance, cash flow, budgets, savings goals and other financial parameters for or over a defined time period such as a month, may have a potential negative impact on said parameters for or over the defined period or may have an actual negative impact on said parameters for or over the defined period. Thus, a proposed purchase has a neutral or negative impact on a user's financial situation. Because a proposed purchase has an inherent cost associated therewith, namely the purchase amount of the purchase data, the impact of the proposed purchase by definition will not increase the absolute values of said parameters.

Applying the impact of proposed purchase to the budget financial parameter, a proposed purchase has a potential negative impact and may cause over budget if the purchase amount of the proposed purchase plus the amount already spent exceeds the budget times the day of the month divided by the number of days in the month. That is, the proposed purchase has a potential negative impact on the budget financial parameter if the total amount spent after the proposed purchase would be higher then what it should be in proportion to the period, for example if on a monthly basis, the month. Specifically, let r be the proportion of the period remaining; in the example of the period being a month, r would be the days remaining in the month/days in the month. The potential negative impact on the budget financial parameter due to purchases/expenses may be referred to as the projected over budget (defined as the variable POB). Then:

POB=MAX[(((purchase amount+other spending over the period)+(budget*r))−budget), 0]. Eq. 1

Two examples of calculating POB using a month period. Budget is 300 and the purchase amount of a proposed purchase plus other spending over the period is 200. It is the tenth day of the month such that there is twenty days remaining in the period of the month. Then POB=MAX[(200+(300*20/30)−300), 0]=[100, 0]=100. Now budget is 300 and the purchase amount of a proposed purchase plus other spending over the period is 375. It is the tenth day of the month such that there is twenty days remaining in the period of the month. Then POB=MAX[(375+(300*20/30)−300), 0]=[275, 0]=275.

Returning to the impact a purchase has on balance, cash flow, budgets, savings goals and other financial parameters for or over a defined time period in the context of POB, a POB>0 indicates a potential negative impact on the budget financial parameter because the projected over budget amount exceeds the budget for the relevant (time) period. A POB>SV indicates a potential negative impact on the cash flow parameter because expenditure (spending) is projected to exceed planned savings for the period. A POB>(SV+SGB) indicates a potential negative impact on the savings goal parameter because expenditure (spending) is projected to exceed the combined planned savings and savings goal buffer for the period. And a POB>(SV+SB) indicates a potential negative impact on the balance parameter because expenditure (spending) is projected to exceed the combined planned savings and starting balance for the period, thereby having a negative impact on the budgeted (that is, desired as specified by the budget) balance parameter.

Similarly, applying the impact of proposed purchase to the budget financial parameter, a proposed purchase has a negative impact and causes over budget if the purchase amount of the proposed purchase plus the amount already spent exceeds the budget. That is, the proposed purchase has a negative impact on the budget financial parameter if the total amount spent after the proposed purchase would be higher than the budget. The negative impact on the budget financial parameter may be referred to as the actual over budget (defined as the variable AOB). Then:

AOB=MAX[((purchase amount+other spending over the period)−budget), 0]. Eq. 2

Two examples with AOB for a month period. Budget is 300 and the purchase amount of a proposed purchase plus other spending over the period is 200. It is any day in the month. Then AOB=MAX[(200−300), 0]=[−100, 0]=0. Now budget is 300 and the purchase amount of a proposed purchase plus other spending over the period is 375. It is any day in the month. Then AOB=MAX[(375−300), 0]=[75, 0]=75.

Returning to the impact a proposed purchase has on balance, cash flow, budgets, savings goals and other financial parameters for or over a defined time period in the context of AOB, an AOB>0 indicates a negative impact on the budget financial parameter because the amount spent (expenditure) exceeds the budget. An AOB>SV indicates a negative impact on the cash flow parameter because the amount spent (expenditure) exceeds the planned savings, resulting in negative cash flow with regard to the planned budget. An AOB>(SV+SGB) indicates a negative impact on the savings goal parameter because the amount spent (expenditure) exceeds the combined planned savings and savings goal buffer. And an AOB>(SV+SB) indicates a negative impact on the balance parameter because the amount spent (expenditure) exceeds both planned savings and the starting balance.

The impact of the proposed purchase may be different with regard to different financial parameters such as balance, cash flow, budgets, savings goals and other financial parameters. For example, a proposed purchase may have an actual negative impact on budget, a potential negative impact on cash flow and have a neutral effect on saving goals and balance parameters.

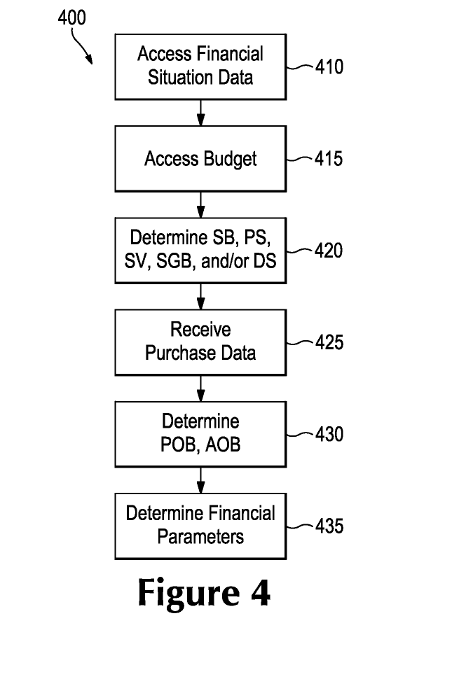

FIG. 4 and flowchart 400 illustrated therein disclose an example methodology for implementing a purchase decision tool at a mobile device. At 410 and 415, the mobile device accesses financial situation data and accesses a budget associated with the user of the mobile device. By accessing the financial situation data and the budget, the mobile device obtains financial data associated with the user, including a balance.

At 420, the mobile device accesses and/or determines the financial data associated with the user and budget parameters from the budget. While the financial situation data and the budget are discussed as separate and distinct, of course, a budget may also include financial situation data associated with a user, such as the balance of one or more accounts associated with a user, and likewise, financial situation data can subsume budget parameters. As part of 420, the purchase decision tool determines a starting balance (SB) for the month, a planned spending (PS) for the month, a planned savings (SV) for the month and a savings goal buffer (SGB). The purchase decision tool may further access or determine a sum of all monthly budgets (DS).

At 425, purchase data associated with a proposed purchase is received at the mobile device. This purchase data comprises a purchase amount corresponding to the proposed purchase. This purchase data may further comprise a currency associated with the purchase amount and the proposed purchase. The purchase decision tool may normalize the purchase amount into the currency of the financial situation data and budget associated with the user.

At 430, the projected over budget (POB) and actual over budget (AOB) are determined. This may be done using the purchase data and Equations 1 and 2, above. At 435, financial parameters are determined based on the POB and AOB determined at 430. In one example, the financial parameters of balance, cash flow, budgets, and savings goals may be determined by comparison(s) of the POB and AOB with 0, SB, PS, SV, and/or SGB, and perhaps DS, as, for example, discussed above.

The determination of these financial parameters of balance, cash flow, budgets, and savings goals as described above is dependent on the purchase data from the proposed purchase and as such these financial parameters indicate the impact of the proposed purchase on the user's finances. The mobile device may output an indication of these determined financial parameters. For example, elements in a tuple may correspond to the financial parameters, and the state of the element may be determined based upon the impact of the proposed purchase on the corresponding financial parameter. There may be graphical output to the user from the mobile device based upon these determinations.

A proposed purchase and a balance, cash flow, budgets, savings goals and other financial parameters may be associated with one or more categories. Specifically, each of a proposed purchase and a balance, cash flow, budgets, savings goals and other financial parameters associated with categories may be in or associated with a category. For example, in the event that a user has two incomes, a work income and a trust income, there may be a corresponding balance, cash flow, budgets, savings goals and other financial parameters associated with each income, and these may be distinct and non-overlapping financial categories for the user in that the impact of a proposed purchase on the financial parameters in the categories is different. Similarly, expenses may be organized into different categories in a budget, such as food, clothing, shelter, and other possible categories.

In such a case where the purchase decision tool is adapted for multiple categories, than there may be a respective POB and AOB and other financial parameters corresponding to each category. So, for example, the above equations (Equations 1, 2) are modified to allow for multiple categories:

POB(category)=MAX[(((purchase amount(category)+other spending over the period(category))+(budget(category)*r))−budget(category)), 0]; and Eq. 3

AOB(category)=MAX[((purchase amount(category)+other spending over the period(category))−budget(category)), 0]. Eq. 4

Summed across all categories, the overall POB and AOB would be:

POB=SUM(POB(category)); and Eq. 5

AOB=SUM(AOB(category)), over all relevant categories. Eq. 6

The impact of a purchase can be expressed as a state. For example, as discussed above, the impact of a proposed purchase on a financial parameter such as balance, cash flow, budgets, savings goals and other financial parameter may be neutral, potentially negative or (actually) negative. In one embodiment utilizing a state machine, the state machine may be configured to output states based at least on an input of purchase data associated with a proposed purchase. In one embodiment, the state may be expressed as a tuple of elements, each element corresponding to a respective financial parameter, and each element may have a state of neutral, potentially negative or negative expressed as green, yellow or red, respectively. Thus, one example tuple is an ordering of best to worst outcomes on financial parameters with regard to a proposed purchase. That is, a tuple of financial parameters may be defined as: (budget, cash flow, savings goal, balance amount); with green, yellow or red expressing a state of the elements and abbreviated g, y, r, respectively. Thus, a state expressed as (r, y, g, g) signifies that a proposed purchase has a negative impact with regard to budget (as indicated by red), has a potentially negative impact with regard to cash flow (as indicated by yellow), has a neutral impact on savings goal (as indicated by green), and has a neutral impact on balance (as indicated by green).

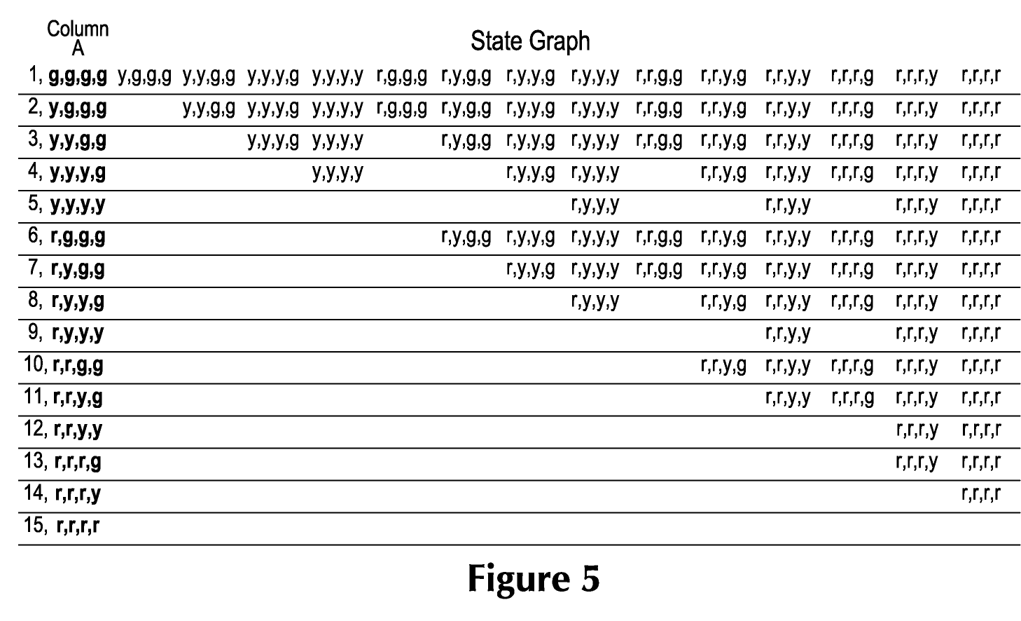

As discussed above, a mobile device can determine a state based upon the proposed purchase to provide an indication of the impact of the proposed purchase. FIG. 5 is a State graph showing possible states of the above-defined tuple of elements: (budget, cash flow, savings goal, balance amount). Column A of FIG. 5 lists the possible states as entries 1-15 and the rows corresponding to each entry in column A take the number of the corresponding entry and list the possible states that can result based upon the impact of the proposed purchase. So for example, a tuple with a state of (r, r, r, y) can stay the same or result in (r, r, r, r) due to a proposed purchase, as shown in row 14. That is to say, if a user is in a situation where the user is over-budget, has a negative cash flow, is not meeting the savings goal, but still has some balance, then a further purchase (the proposed purchase) can only leave him in the same financial state, or worsen the user's financial state by taking the user over balance. Or for example, as shown in row 9, a tuple with a state of (r, y, y, y) can stay the same or result in (r, r, y, y), (r, r, r, y), or (r, r, r, r) due to a proposed purchase, because a proposed purchase impact on a state corresponding to a financial parameter of the tuple is either neutral, potentially negative or negative, as discussed above.

To provide the user with an overall indication of the impact of the proposed purchase, the possible states may be equated with a respective overall score. There are, of course, various possible correlations between overall score and state, and chart 1, below, provides an example correlation between possible states and a number indicative of an overall score:

| Defined | | | | |
|---|---|---|---|---|
| Score | | State Machine States | | |
| 0 | ≡ | gggg | | |
| 1 | ≡ | yggg | | |
| 2 | ≡ | rggg | yygg | |
| 3 | ≡ | rygg | yyyg | |
| 4 | ≡ | rrgg | yyyy | ryyg |
| 5 | ≡ | rryg | ryyy | |
| 6 | ≡ | rrrg | rryy | |
| 7 | ≡ | rrry | | |
| 8 | ≡ | rrrr | | |

So, when the state is a tuple (g, g, g, g) indicating there is neutral impact on all of the corresponding budget, cash flow, savings goal, and balance amount financial parameters, the corresponding score is defined as 0, indicating no impact. When the state is a tuple (r, r, r, r) indicating there is a (actual) negative impact on all of the corresponding budget, cash flow, savings goal, and balance amount financial parameters, the corresponding score is defined as 8, indicating high impact. Other states between these two antipodal extremes have an intermediate score assigned thereto, depending upon the severity of the impact indicated by the state of the tuple. For example, the state (y, g, g, g) is equated with a 1, indicating light impact, and the state (r, r, r, y) is equated with 7, indicating second highest impact.

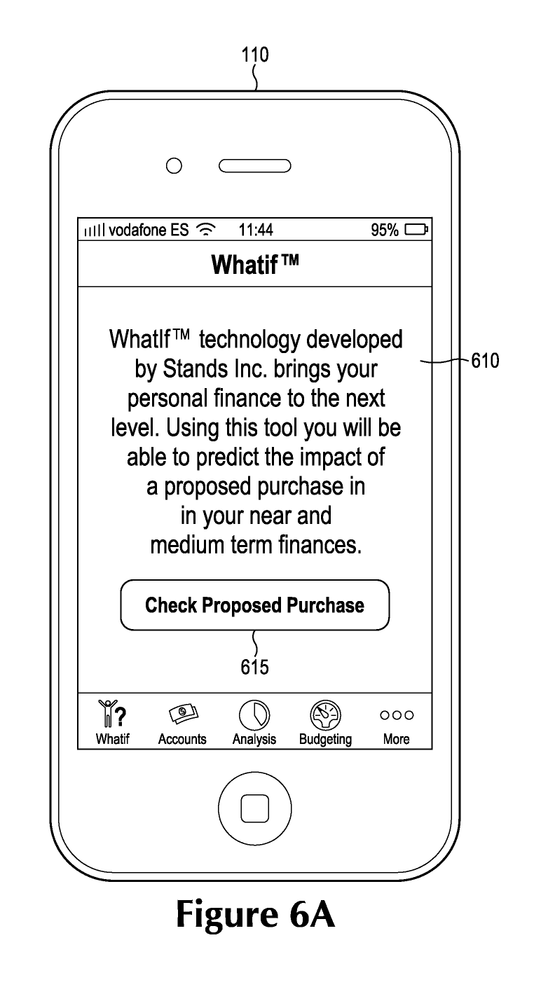

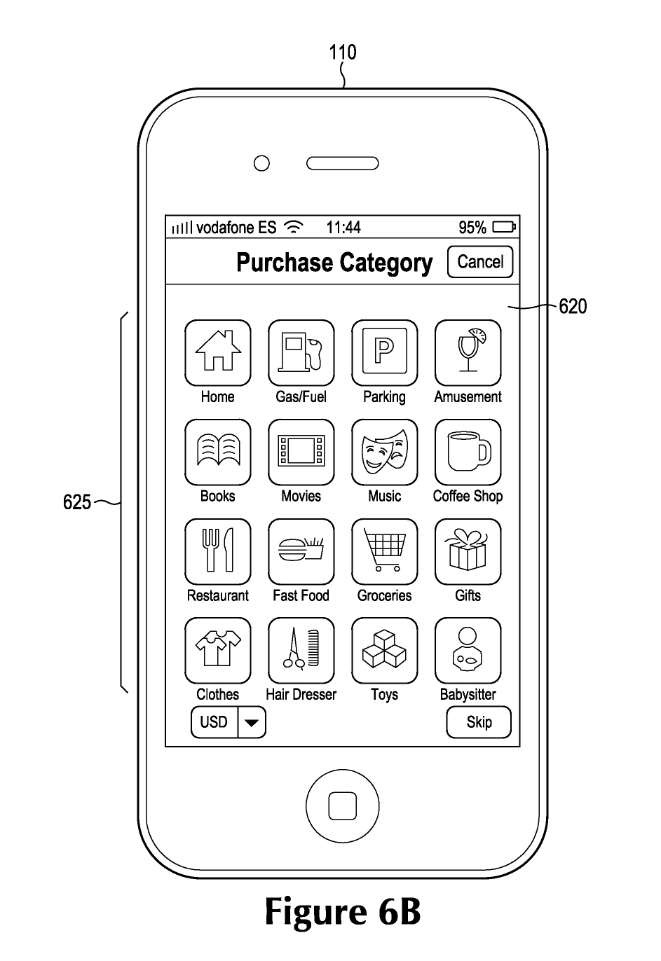

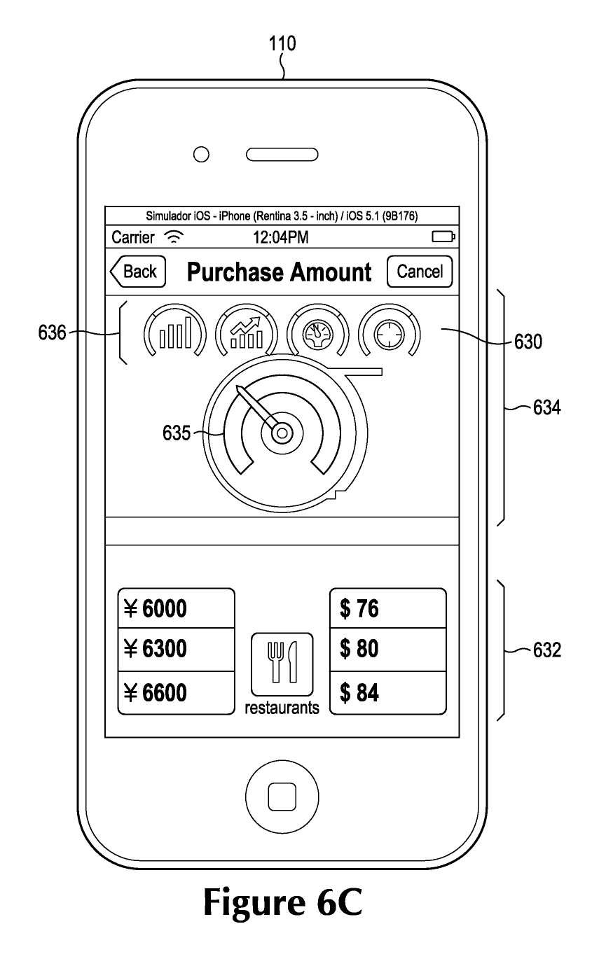

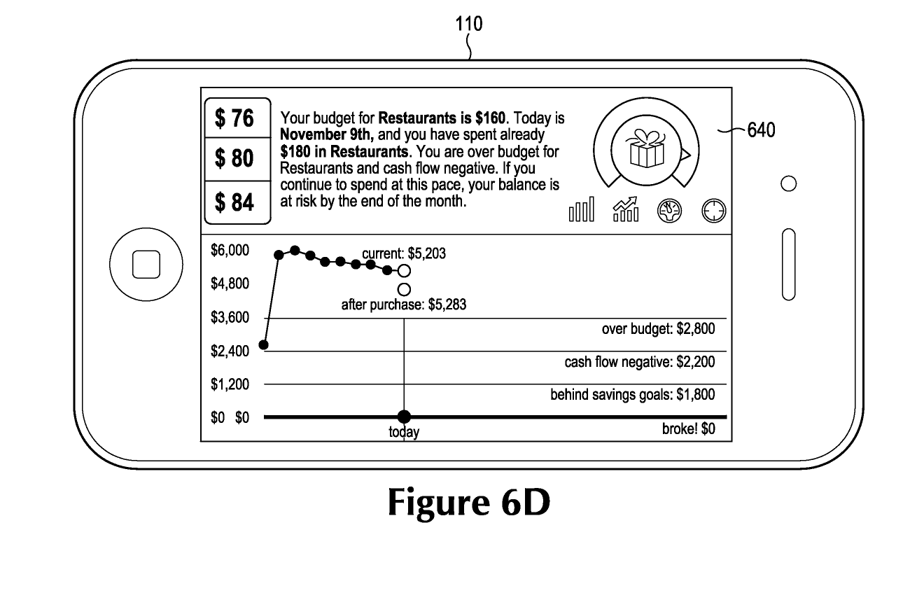

The resulting states may be displayed in any number of ways on a graphical user interface for a mobile device. FIGS. 6A-6D illustrates graphical user interface aspects of the purchase decision tool executed on a mobile device with touchscreen input/output. FIG. 6A illustrates an example of a mobile device 110 executing a purchase decision tool and a corresponding interface 610 on the touchscreen with a button 615 for checking a proposed purchase using the purchase decision tool. FIG. 6B shows an optional category selection interface 620 with touch buttons 625 on the touchscreen for selection of a category of the proposed purchase. For example, the user may select a clothes category to determine the impact of a proposed purchase relating to clothes may have on his budget allocation for clothes over a defined period such as a month.

FIG. 6C illustrates an interface 630 for entering the purchase amount of a proposed purchase together with a currency designation on a sub-portion 632 of the touchscreen. Interface 630 further comprises an output section 634 on the touchscreen for outputting illustrations of the impact of the proposed purchase. There is an overall impact indicator 635 indicating the overall impact on the user's finances, and a set of four other indicators 636 which indicate the effect of the proposed purchase on (from left to right) the four financial parameters of budget, cash flow, savings goal, and balance amount. Indicators may output a green, yellow, or red output as discussed above, which may be the result of a state machine, as discussed above. FIG. 6D illustrates an interface 640 which presents a graph of the impact of the proposed purchase to a user with an over budget and cash flow warning and the indicators of FIG. 6C reproduced.

It will be obvious to those having skill in the art that they may make many changes to the details of the above-described embodiments without departing from the underlying principles of the present description. The scope of the present description, therefore, is to be determined only by the following claims.

What is claimed is:

1. A system comprising:
a server configured to store financial situation data including a balance;
a computation device configured to be in communication with the server to receive the financial situation data and comprising logic configured to determine a state of a tuple of financial indicators, wherein the computation device is configured to access a budget plan and receive proposed purchase data for a proposed purchase including a purchase amount, and compare the proposed purchase data with the budget plan and the financial situation data to determine the state of the tuple of financial indicators; the computation device further comprising output means for outputting the determined state of the tuple of financial indicators.

2. The system of claim 1, wherein the tuple comprises two or more elements, each element corresponding to a respective financial indicator and having a corresponding element state indicating a state of the respective financial indicator.

3. The system of claim 1, wherein the proposed purchase is an individual purchase transaction.

4. The system of claim 1, wherein the financial indicators comprise two or more of: Budget Impact, Cash Flow, Savings Goal(s), and Balance Amount.

5. The system of claim 1, wherein the balance is the Starting Balance for a time period and wherein the budget plan comprises a Planned Spending for the time period, and a Planned Savings for the time period.

6. The system of claim 5, wherein the time period is a month and the budget plan further comprises a Savings Goals Buffer and a monthly budget sum.

7. The system of claim 2, wherein an element state is neutral or negative.

8. The system of claim 1, wherein the comparing the purchase data with the budget plan and the financial situation data comprises calculating a Projected Over Budget value and an Actual Over Budget value.

9. A method comprising:
accessing a budget plan with a mobile device;
receiving financial situation data at the mobile device, wherein said financial situation data comprises a balance;
receiving proposed purchase data at the mobile device, wherein said proposed purchase data comprises a purchase amount and a currency for a proposed purchase;
comparing the proposed purchase data with the budget plan and the financial situation data at the mobile device, including comparing the balance with the purchase amount;
determining a state of a tuple of financial indicators at the mobile device based on the comparing the proposed purchase data with the budget plan and the financial situation data; and
outputting an indication of the state of the tuple of financial indicators from the mobile device.

10. The method of claim 9, wherein the tuple comprises two or more elements, each element corresponding to a respective financial indicator and having a corresponding element state.

11. The method of claim 10, wherein the financial indicators comprise: Budget Impact, Cash Flow, Savings Goal(s), and Balance Amount.

12. The method of claim 10, wherein the balance is the Starting Balance for a month and wherein the budget plan comprises a Planned Spending for the month, and a Planned Savings for the month.

13. The method of claim 12, wherein the budget plan further comprises a Savings Goals Buffer and a monthly budget sum.

14. The method of claim 9, wherein the proposed purchase is an individual purchase transaction.

15. The method of claim 10, wherein an element state is neutral or negative.

16. The method of claim 10, wherein the comparing the purchase data with the budget plan and the financial situation data comprises calculating a Projected Over Budget value and an Actual Over Budget value.

17. A computer accessible non-transitory memory medium comprising program instructions stored thereon that, in response to execution by a processing device, cause the processing device to perform operations comprising:
accessing a budget plan;
receiving financial situation data, wherein said financial situation data comprises a balance;
receiving proposed purchase data, wherein said proposed purchase data comprises a purchase amount and a currency for a proposed purchase;
comparing the proposed purchase data with the budget plan and the financial situation data, including comparing the balance with the purchase amount;
determining a state of a tuple of financial indicators based on the comparing the proposed purchase data with the budget plan and the financial situation data; and
outputting an indication of the state of the tuple of financial indicators.

18. The computer accessible non-transitory memory medium of claim 17, wherein the tuple comprises two or more elements, each element corresponding to a respective financial indicator and having a corresponding element state.

19. The computer accessible non-transitory memory medium of claim 17, wherein the financial indicators comprise two or more of: Budget Impact, Cash Flow, Savings Goal(s), and Balance Amount.

20. The computer accessible non-transitory memory medium of claim 17, wherein the balance is the Starting Balance for a month and wherein the budget plan comprises a Planned Spending for the month, and a Planned Savings for the month.

21. The computer accessible non-transitory memory medium of claim 20, wherein the budget plan further comprises a Savings Goals Buffer and a monthly budget sum.

22. The computer accessible non-transitory memory medium of claim 17, wherein the proposed purchase is an individual purchase transaction.

23. The computer accessible non-transitory memory medium of claim 18, wherein an element state is neutral or negative.

24. The computer accessible non-transitory memory medium of claim 17, wherein the budget plan comprises a plurality of categories and the proposed purchase data comprises a category indication indicating a category from among the plurality of categories, the processing device performing further operations comprising: comparing the proposed purchase data with the budget plan and the financial situation data with regard to the category.
